(19) United States
(12) Patent Application Publication
(10) Pub. No.: US 2022/0351442 A1
(43) Pub. Date: Nov. 3, 2022

(54) ANIMATION PRODUCTION SYSTEM

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(21) Appl. No.: 16/977,061

(22) PCT Filed: Sep. 24, 2019
(86) PCT No.: PCT/JP2019/037411

§ 371 Date: Aug. 31, 2020

(51) Int. Cl. G06T 13/40; G06T 19/00; G06F 3/02; G06F 3/0346

(52) U.S. Cl. CPC G06T 13/40; G06T 19/00; G06F 3/02; G06F 3/0346; G06F 3/012

(57) ABSTRACT

To enable to shoot animations in a virtual space, an animation production system comprises a virtual camera that takes pictures of a character placed in a virtual space; a user input detection unit that detects an input of a user from at least one of a head mounted display and a controller which the user mounts; and a mode controller that switches a first mode to view the virtual space from above, a second mode to operate a character disposed in the virtual space, and a third mode to operate the camera in response to the input

### TECHNICAL FIELD

The present invention relates to an animation production system.

### BACKGROUND ART

Virtual cameras are arranged in a virtual space (see Patent Document 1).

### CITATION LIST

### Patent Literature

Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem includes an animation production system, comprising: a virtual camera for taking a character disposed in a virtual space; a user input detecting unit for detecting the user input from at least one of a head mount display and a controller mounted by a user; a first mode for birds-eye view of the virtual space; a second mode for operating a character disposed in the virtual space; and a mode controller for switching a third mode for operating the camera.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating an example of a functional configuration of an image producing device 310 according to the present embodiment;

FIG. 8 is a diagram illustrating a process flow pertaining to the operation of the control panel 6;

### DESCRIPTION OF EMBODIMENTS

The contents of embodiments of the present invention will be described with reference. The present invention includes, for example, the following configurations.

### Item 1

An animation production system comprising:
a virtual camera that takes pictures of a character placed in a virtual space;
a user input detection unit that detects an input of a user from at least one of a head mounted display and a controller which the user mounts; and
a mode controller that switches a first mode to view the virtual space from above, a second mode to operate a character disposed in the virtual space, and a third mode to operate the camera in response to the input.

### Item 2

The animation production system according to claim 1, further comprising
a control panel including a mode switching button for switching the first to third modes; and a camera image display unit for displaying an image captured by the camera.

### Item 3

The animation production system according to claim 1, wherein
the control panel further comprises a camera switching button for switching the camera for the camera image display unit when a plurality of the cameras are disposed.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

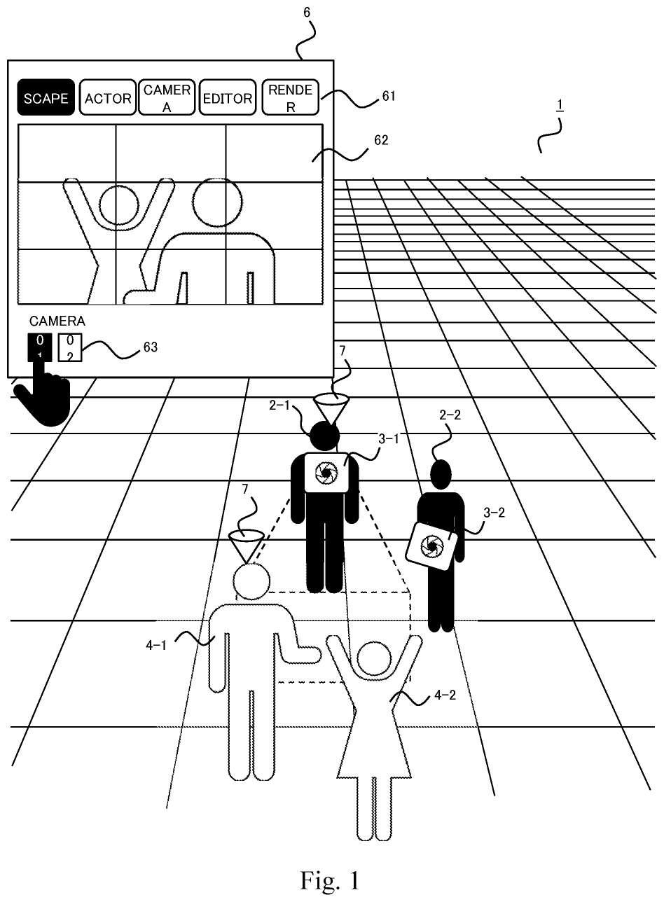

FIG. 1 is a diagram illustrating an example of a virtual space displayed on a head mount display (HMD) mounted by a user in an animation production system 300 according to the present embodiment. The animation production system 300 according to the present exemplary embodiment is intended to create an animation by placing a virtual character 4 and a virtual camera 3 in a virtual space 1 and taking a character 4 using a camera 3.

In the virtual space 1, a photographer 2 (a character of the photographer) is disposed, and the camera 3 is virtually operated by the photographer 2. In the animation production system 300 of this embodiment, as shown in FIG. 1, the user arranges the character 4 and the camera 3 while viewing the virtual space 1 in TPV (Third Person View) from the higher perspective, shoots the character 4 in the FPV (First Person View) as the photographer 2, and performs the performance of the character 4 in the FPV, while producing the animation. Within virtual space 1, a plurality of cameras 2 (in the example of FIG. 1, cameras 2-1 and 2-2) may be disposed, and cameras 2-1 and 2-2 may be switched to switch video from camera 2 which is employed in the final animation.

In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e. g. , characters 4-1 and 4-2).

In this manner, in the animation production system 300 of the present embodiment, one can play a number of roles (roles). In addition, since the camera 2 can be virtually operated as the photographer 2, natural camera work can be realized and the representation of the movie to be shot can be enriched.

### General Configuration

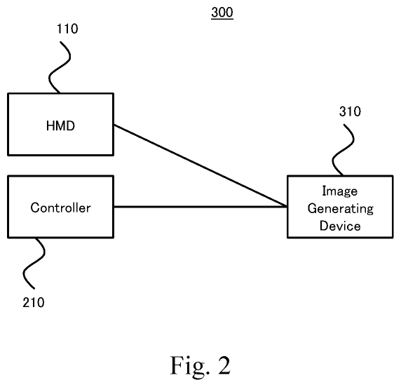

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### HMD 110

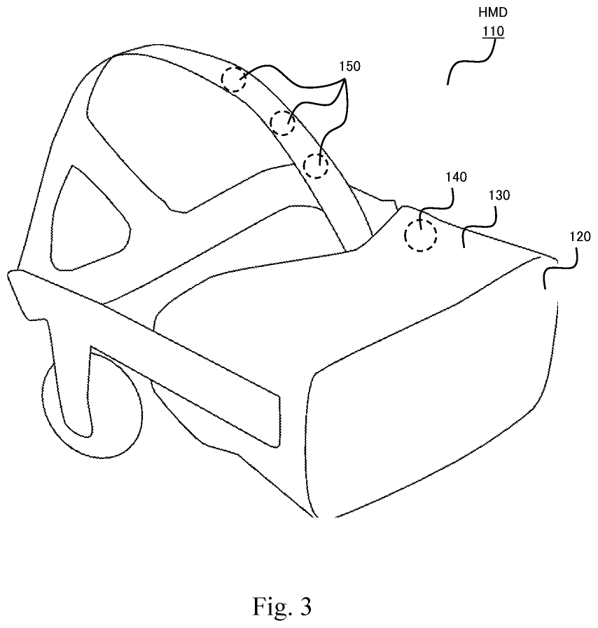

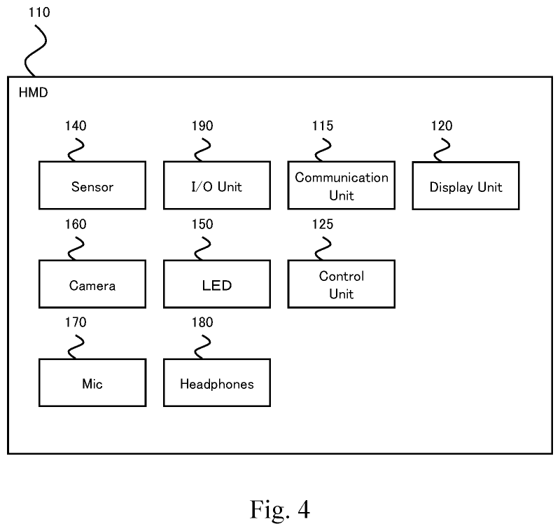

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the parallax of both eyes. If left-eye and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e. g. , infrared light LEDs, visible light LEDs). A camera (e. g. , an infrared light camera, a visible light camera) installed outside the HMD 110 (e. g. , indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

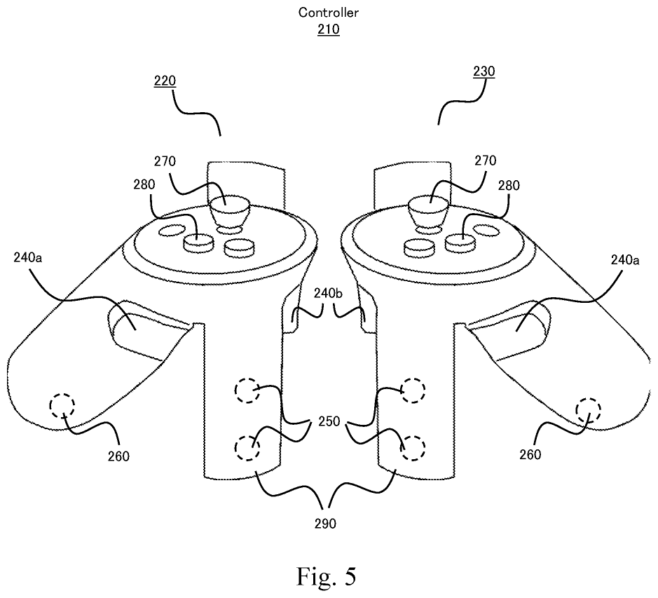

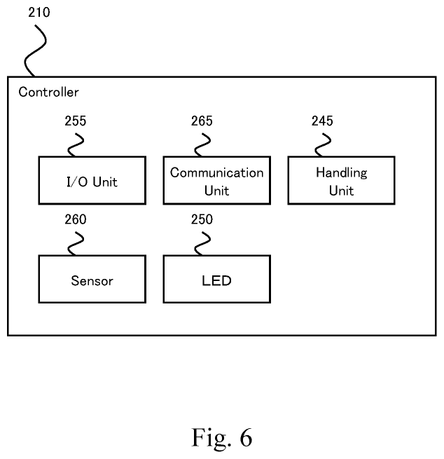

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

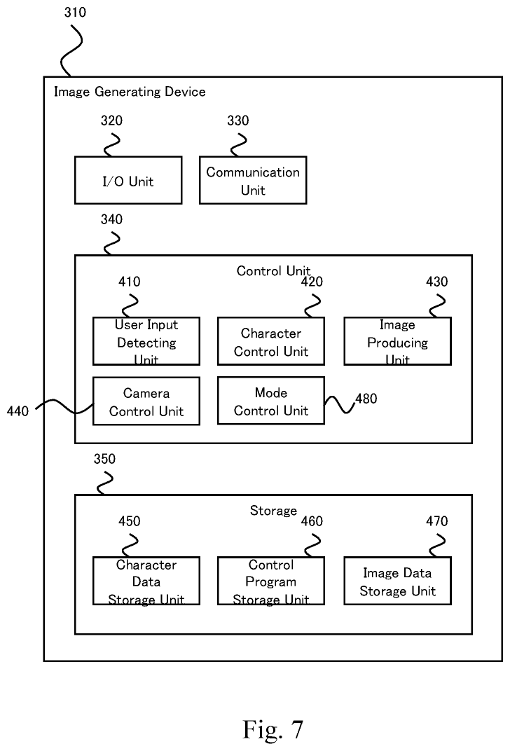

FIG. 7 is a diagram illustrating an example of a functional configuration of an image producing device 310 according to this embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding movement of the user's head, user speech, and movement and operation of the controller, a character control unit 420 that executes a control program stored in the control program storage unit 460 for a character data storage unit 450 of the storage unit 350, a camera control unit 440 that controls a virtual camera 3 disposed in the virtual space 1 in accordance with a character control unit 460, a mode control unit 480 that changes the control mode of the system, and an image producing unit 430 that generates an image in which the camera 3 captures the virtual space 1 based on a character control mode. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings (e. g. , the position of the camera 3 within the virtual space 1, the shooting direction, the focus position, and the zoom of the camera 3) with respect to the camera 3 according to the movement of the hand of the character 4.

The storage unit 350 stores in the aforementioned character data storage unit 450 information related to the character 4, such as the attribute of the character 4, as well as the image data of the character 4. The control program storage unit 460 stores a program for controling the operation and expression of the character 4 in the virtual space and controlling an object such as the camera 3. The image data storage unit 470 stores the image generated by the image producing unit 430.

### Control Panel 6

The control mode of the animation production system 300 is set by the mode control unit 480. Note that the default can be birds-eye view mode. The user can change the control mode by operating the control panel 6. As shown in FIG. 1, the control panel 6 is disposed in the virtual space 1. The control panel 6 can be located in a free position by user operation. The user can move the control panel 6 to a position that does not interfere with the operation of the camera 3 or the performance as a character 4 when operating the camera 2 or character 4 with the FPV. For example, by moving the fingers near the end of the control panel 6 and depressing the trigger button 240 to grasp the control panel 6 while moving the controller 210, the mode control portion 480 may move the control panel 6 in response to movement of the controller 210.

The control panel 6 includes a mode switching button 61 for changing the control mode, a camera image display unit 62 for displaying the camera image captured by the camera 3, and a camera switching button 63 for switching the camera 3. In the example of FIG. 1, the mode switching button 61 includes a “SCAPE” button for switching to a bird's-eye view mode that takes a bird's-eye view of the virtual space 1, an “”ACTOR“” button for switching to a performance mode in which the character 4 is possessed and performed, and a “CAMERA” button for switching to a camera mode in which the camera 3 is operated by the camera 2. In addition, only one of these buttons may be disposed on the control panel 6.

### Modify Mode

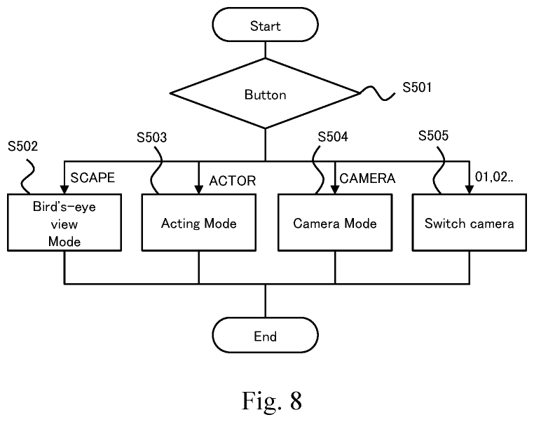

FIG. 8 is a diagram illustrating a flow of processing pertaining to the operation of the control panel 6. The processing of FIG. 8 is performed when some button is tapped in the control panel 6.

When the SCAPE button is tapped in the control panel 6 (S501: SCAPE), the control mode becomes the bird's-eye view mode (S502). In the birds-eye view mode, as shown in FIG. 1, a screen that takes a birds-eye view of the virtual space 1 is displayed on the display panel 120. The user may change the position of the character 4, place a new character 4, change the position of the camera 3, or place a new camera 3. When two or more cameramans are disposed, or when multiple characters 4 are disposed, the cameraman 2 and the character 4 that are the object of inspection (to be operated) can be specified at the time of switching the control mode. For example, when the cameraman 2 in the virtual space 1 is tapped in the bird's-eye mode, the mode control unit 480 can be set such that the tapped cameraman 2 becomes an operation target when the camera mode is turned. In the bird's-eye view mode, when the character 4 in the virtual space 1 is tapped, the mode control unit 480 can set the tapped character 4 to be an operation target when the character 4 is in the performance mode. The mode control unit 480 may display a mark 7 indicating the camera man 2 and the character 4 to be operated.

When the ACTOR button is tapped in the control panel 6 (S501: ACTOR), the control mode becomes the performance mode (S503). In the performance mode, the first person image (FPV) of the character 4 is displayed on the display panel 120, and the user can control the operation of the character 4 by the operation of the controller 210 and the HMD 110 to perform the performance of the character 4. When the plurality of characters 4 is disposed, as described above, the user can operate the character 4 that is set as the operation target. When an acoustic engineer with a virtual audio microphone or an assistant with a reflex plate is arranged, the performance mode can be an operation mode in which a character 4 having a roll such as an acoustic engineer or assistant is operated.

When the CAMERA button is tapped in the control panel 6 (S501: CAMERA), the control mode becomes the camera mode (S504). In the camera mode, the first image (FPV) of the photographer 2 is displayed on the display panel 120, and the user can control the camera 3 by the operation of the controller 210 and take a photograph with the camera 3. When the plurality of cameras 3 is disposed, as described above, the user can operate the camera man 2 that is set as the operation target.

When any of the camera switching buttons 63 is tapped in the control panel 6 (S501: 01, 02 . . . ), the mode control unit 480 sets the camera 3 to be displayed on the camera image display unit 62 (S505).

As described above, the user can use the control panel 6 to switch between the camera mode which is the first person's viewpoint of the photographer 2, the performance mode which is the first person's viewpoint of the character 4, and the bird's-eye view mode which is the third person's viewpoint of the virtual space 1. At the same time, in the control panel 6, the camera 3 can be switched to display the image from the camera 3.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### Explanation of Symbols

1 virtual space

2 cameraman

3 cameras

4 characters

6 control panel

61 Mode Switching Button

62 Camera image display

63 camera switch button

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

480 mode controller

510 handle

520 display

530 rail

540 slider

550 recording button

1. An animation production system comprising:
a virtual camera that takes pictures of a character placed in a virtual space;
a user input detection unit that detects an input of a user from at least one of a head mounted display and a controller which the user mounts; and
a mode controller that switches a first mode to view the virtual space from above, a second mode to operate a character disposed in the virtual space, and a third mode to operate the camera in response to the input.

2. The animation production system according to claim 1, further comprising
a control panel including a mode switching button for switching the first to third modes; and a camera image display unit for displaying an image captured by the camera.

3. The animation production system according to claim 1, wherein
the control panel further comprises a camera switching button for switching the camera for the camera image display unit when a plurality of the cameras are disposed.
